(19) United States
(12) Patent Application Publication
(10) Pub. No.: US 2009/0070335 A1
(43) Pub. Date: Mar. 12, 2009

(54) SYSTEM AND METHOD FOR WEB PROCESSING MONITORING

(76) Inventors: Costin V. Cozianu, Torrance, CA (US); George Koppich, Palos Verdes Estates, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,159

(22) Filed: Sep. 6, 2007

(51) Int. Cl. G06F 17/30

(52) U.S. Cl. 707/10; 707/E17.116

(57) ABSTRACT

The subject application is directed to a system and method for web process monitoring. The commencement of an active web services process is first detected, and in response to such detection, a supervisory system is commenced. The active web services process is then monitored. Stored parameter data representing at least one acceptable property associated with the active web services process is then compared to the monitored web services process. The supervisory system is then activated based upon the results of the comparison. Thereafter, the activated supervisory system controls operation of the active web services process.

### BACKGROUND OF THE INVENTION

The subject application is directed generally to preventing server overload in conjunction with provision of web services. The system and method of the subject application is particularly applicable to prevention or alleviation of degraded web services.

Current web services, such as those used on the Internet or through the World Wide Web, typically employ interaction between a web server and a thin client on a remote, networked computer. Typical thin clients include Internet Explorer, Mozilla Opera, or any other suitable web browser. Web browsers are available on many systems and work in concert with many operating system environments.

Web browsers interact with web servers by opening of active web sessions. Current web services architectures include JAVA J2EE and Microsoft .NET frameworks. Such processes frequently suffer from performance degradation, particularly as a result of long running processes. This is experienced in systems employing a managed, virtual machine environment. Factors leading to such degraded performance may include limitations of virtual machine technology, flaws in application code, heavy memory usage, numbers of open files, numbers of database connections, numbers of pointers, and the like.

Given the foregoing, it is not unusual for web services clients to stop responding or suffer complete failure. Substantial degradation is also experienced even before failure, resulting in substantially lessened efficiency in use of web services.

### SUMMARY OF THE INVENTION

In accordance with one embodiment of the subject application, there is provided a system and method for preventing server overload in conjunction with provision of web services.

Further, in accordance with one embodiment of the subject application, there is provided a system and method that is particularly applicable to prevention or alleviation of degraded web services.

Still further, in accordance with one embodiment of the subject application, there is provided a web monitoring system. The system comprises detection means adapted for detecting a commencement of an active web services process and responsive to the detection means, means adapted for commencing a supervisory system upon detection of a commenced active web services process. The system also comprises monitoring means adapted for monitoring the active web services process, means adapted for storing parameter data representative of at least one acceptable property associated with the active web services process, and comparison means adapted for comparing a monitored active web services process with stored parameter data. The system further includes means adapted for activating the supervisory system in accordance with an output of the comparison means and control means adapted for controlling operation of the active web services process via an activated supervisory system.

In one embodiment of the subject application, the parameter data includes data representative of at least one characteristic chosen from the set comprising memory usage, number of open files, number of database connections, and number of pointers.

In another embodiment of the subject application, the control means includes termination means adapted for terminating the active web services process. Preferably, in such embodiment, the system also comprises means adapted for commencing a subsequent active web services process upon termination of a prior active web services process.

In yet another embodiment of the subject application, the system further comprises a timer adapted for measuring a timing associated with activation of the supervisory system and termination control means adapted for controlling the termination means in accordance with an output of the timer. Preferably, in such embodiment, the termination control means operates in accordance with a pre-set timeout duration.

Still further, in accordance with one embodiment of the subject application, there is provided a method for monitoring web services process in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a web process monitoring system according to one embodiment of the subject application;

FIG. 2 is a block diagram illustrating controller hardware for use in the web process monitoring system according to one embodiment of the subject application;

FIG. 3 is a functional diagram illustrating the controller for use in the web process monitoring system according to one embodiment of the subject application;

FIG. 4 is a block diagram illustrating a server for use in the web process monitoring system according to one embodiment of the subject application;

FIG. 5 is a block diagram illustrating a workstation for use in the web process monitoring system according to one embodiment of the subject application;

FIG. 6 is a flowchart illustrating a method for web process monitoring according to one embodiment of the subject application; and

FIG. 7 is a flowchart illustrating a method for web process monitoring according to one embodiment of the subject application.

### DETAILED DESCRIPTION OF THE PREFERRED EMBODIMENT

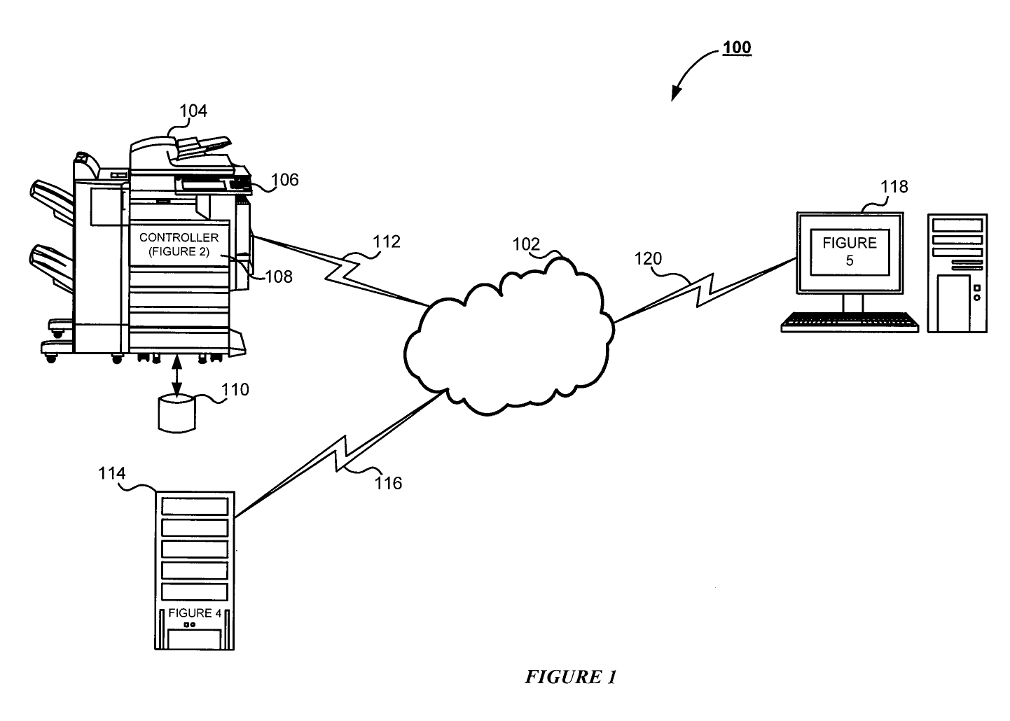

The subject application is directed to a system and method for preventing server overload in conjunction with provision of web services. In particular, the subject application is directed to a system and method that is particularly applicable to prevention or alleviation of degraded web services. It will become apparent to those skilled in the art that the system and method described herein are suitably adapted to a plurality of varying electronic fields employing web-based processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for web process monitoring in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. It will be understood by those skilled in the art that the document processing device 104 is capable of providing services via web-based applications, to a plurality of various networked devices. That is, the document processing device 104 is capable of functioning as a server in a client/server relationship, as will be understood by those skilled in the art.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

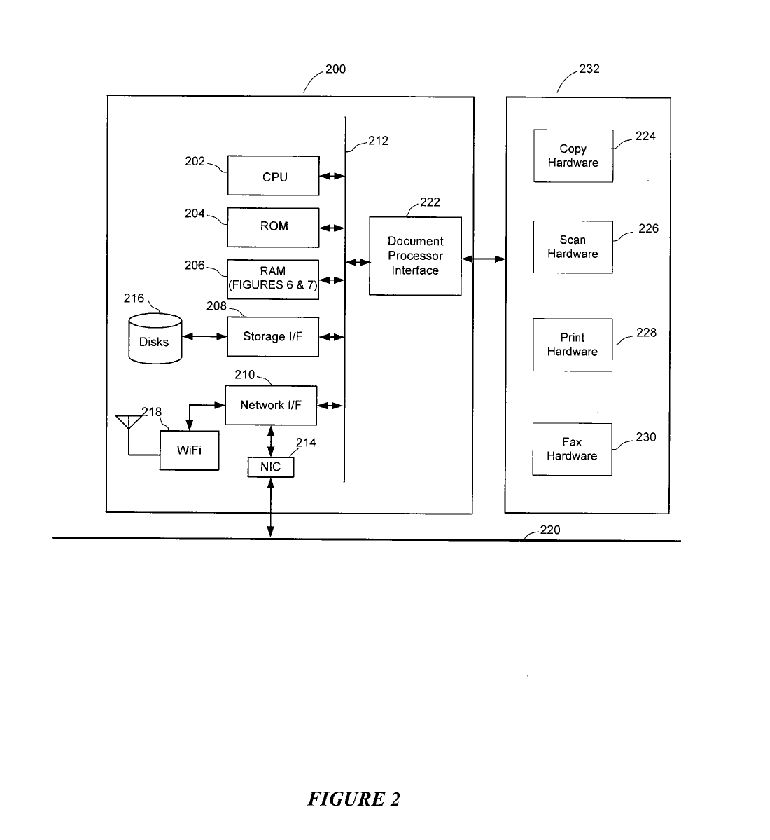

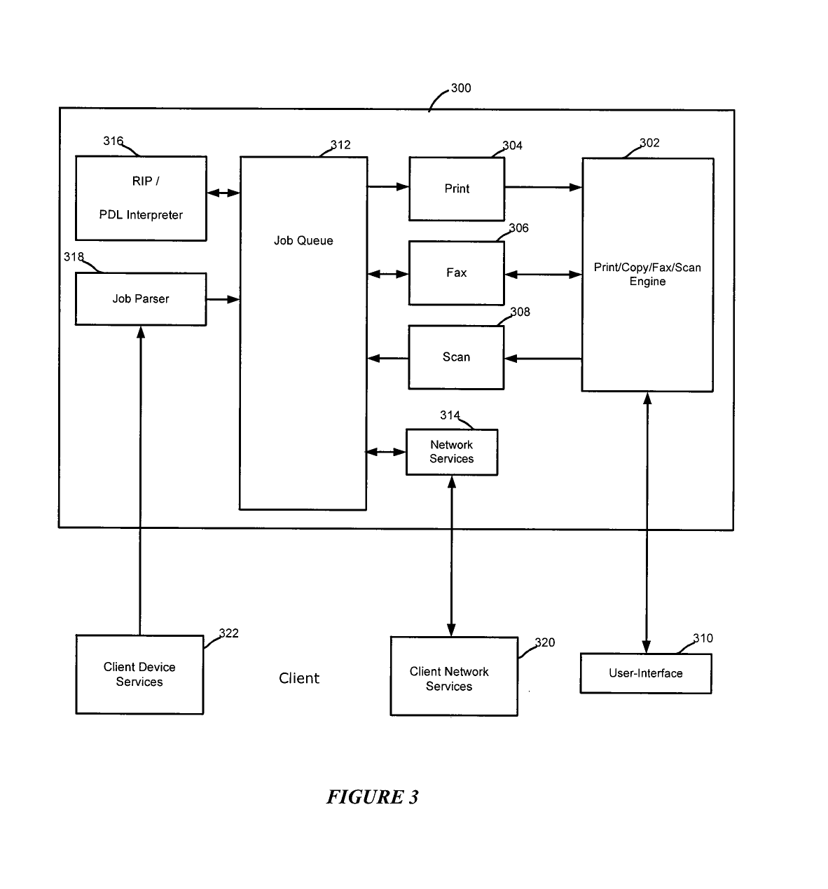

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for web process monitoring of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

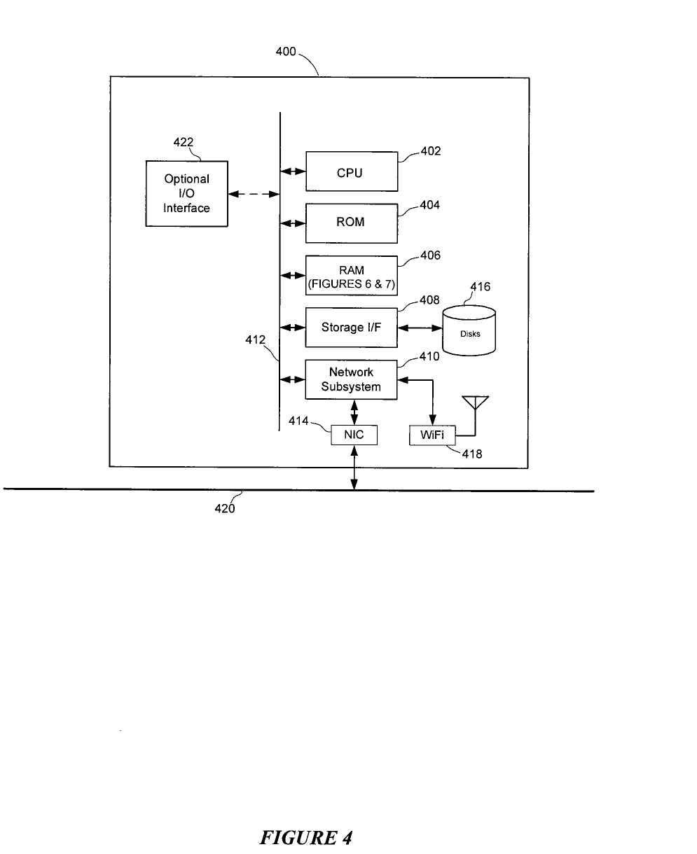

The system 100 of FIG. 1 also includes a network server 114, communicatively coupled to the computer network 102 via a communications link 116. It will be appreciated by those skilled in the art that the server 114 comprises hardware, software, and combinations thereof suitably adapted to provide one or more services, web-base applications, storage options, and the like, to networked devices. In accordance with one embodiment of the subject application, the server 114 includes various components, implemented as hardware, software, or a combination thereof, for managing the performance of web services processes accessed via the computer network 102. The communications link 116 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components for managing processes described with respect to the server 114 hereinafter are capable of implementation on any computing device coupled to the computer network 102 and functioning as a server side of a client/server relationship. The functioning of the server 114 will better be understood in conjunction with the block diagrams illustrated in FIG. 4, explained in greater detail below.

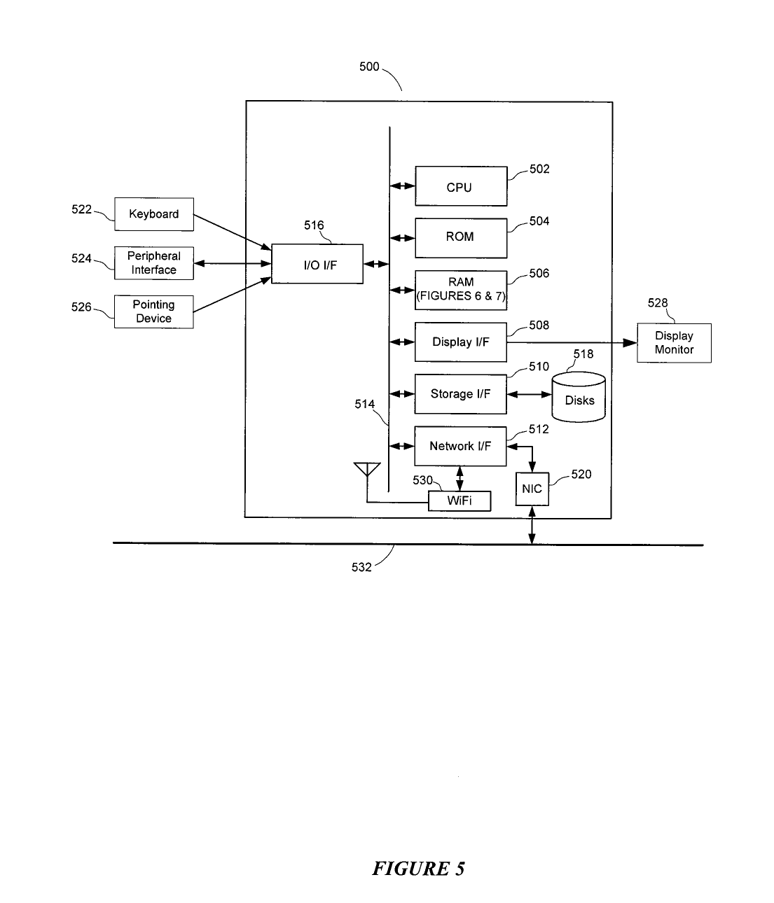

The system 100 illustrated in FIG. 1 further depicts a user device 118, in data communication with the computer network 102 via a communications link 120. It will be appreciated by those skilled in the art that the user device 118 is shown in FIG. 1 as a laptop computer for illustration purposes only. As will be understood by those skilled in the art, the user device 118 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 120 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 118 is suitably adapted to employ a thin client, such as a web browser, for communication with the document processing device 104, the server 114, or the like. It will be appreciated by those skilled in the art that the user device 118 is further capable of requesting services to be performed by the document processing device 104, the server 114, or other component via the computer network 102, using such a thin client. The functioning of the user device 118 will better be understood in conjunction with the block diagrams illustrated in FIG. 5, explained in greater detail below.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable server 400, shown in FIG. 1 as the server 114, on which operations of the subject system are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by the processor 402.

A storage interface 408 suitably provides a mechanism for volatile, bulk or long term storage of data associated with the server 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the server 400 to communicate to other devices. The network interface subsystem 410 suitably interfaces with one or more connections with external devices to the server 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network subsystem 410 is suitably accomplished via a bus data transfer mechanism, such as illustrated by bus 412.

Suitable executable instructions on the server 400 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 422 as will be appreciated by one of ordinary skill in the art.

Turning now to FIG. 5, illustrated is a hardware diagram of a suitable workstation 500, depicted in FIG. 1 as the user device 118, for use in connection with the subject system. A suitable workstation includes a processor unit 502 which is advantageously placed in data communication with read only memory 504, suitably non-volatile read only memory, volatile read only memory or a combination thereof, random access memory 506, display interface 508, storage interface 510, and network interface 512. In a preferred embodiment, interface to the foregoing modules is suitably accomplished via a bus 514.

The read only memory 504 suitably includes firmware, such as static data or fixed instructions, such as BIOS, system functions, configuration data, and other routines used for operation of the workstation 500 via CPU 502.

The random access memory 506 provides a storage area for data and instructions associated with applications and data handling accomplished by the processor 502.

The display interface 508 receives data or instructions from other components on the bus 514, which data is specific to generating a display to facilitate a user interface. The display interface 508 suitably provides output to a display terminal 528, suitably a video display device such as a monitor, LCD, plasma, or any other suitable visual output device as will be appreciated by one of ordinary skill in the art.

The storage interface 510 suitably provides a mechanism for non-volatile, bulk or long term storage of data or instructions in the workstation 500. The storage interface 510 suitably uses a storage mechanism, such as storage 518, suitably comprised of a disk, tape, CD, DVD, or other relatively higher capacity addressable or serial storage medium.

The network interface 512 suitably communicates to at least one other network interface, shown as network interface 520, such as a network interface card, and wireless network interface 530, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 520 is interconnected for data interchange via a physical network 532, suitably comprised of a local area network, wide area network, or a combination thereof.

An input/output interface 516 in data communication with the bus 514 is suitably connected with an input device 522, such as a keyboard or the like. The input/output interface 516 also suitably provides data output to a peripheral interface 524, such as a USB, universal serial bus output, SCSI, Firewire (IEEE 1394) output, or any other interface as may be appropriate for a selected application. Finally, the input/output interface 516 is suitably in data communication with a pointing device interface 526 for connection with devices, such as a mouse, light pen, touch screen, or the like.

In operation, a commencement of an active web services process is first detected. In response to the detection of the commencement of an active web services process, a supervisory system is commenced. Monitoring of the active web services process is then performed. Parameter data representing at least one acceptable property associated with the active web services process is then stored and the monitored web services process is compared to the stored parameter data. The supervisory system is then activated based upon the results of the comparison. The activated supervisory system thereafter controls operation of the active web services process.

In accordance with one example embodiment of the subject application, a web services request is received from a client, e.g., a thin client resident on the user device 118. As will be appreciated by those skilled in the art, the document processing device 104, or the server 114, as illustrated in FIG. 1, are capable of functioning as a server in a client/server relationship. For example purposes only, reference in this example is made hereinafter to the server 114 as the server-side of the client/server relationship with the user device 118 representative of the client-side. The web services request is received by a web services front end component of the server 114, which adds the request in a suitable web service request thread. The web services request is thereafter communicated to a suitable messaging system component of the server 114, which adds the request to a first-in-first-out (FIFO) queue with a switching implementation, as will be explained in greater detail below. In accordance with one embodiment of the subject application, the communications between various components of the server 114 are enabled via extensible markup language messaging, as will be appreciated by those skilled in the art.

An active processor, corresponding to the requested web services process, is then initiated along with a passive processor, each of which is capable of performing the requested web services process. A supervisory system is then commenced, i.e., a supervising component of the server 114 suitably adapted for monitoring and controlling of various web services running on the server 114. The active web services process is then continually monitored by the supervisory system. That is, the monitored active web service process is compared to parameter data stored on the server 114 corresponding to normal operation of the server. According to one embodiment of the subject application, the parameter data includes, for example and without limitation, memory usage, number of open files, number of database connections, number of pointers, and the like. Thus, the supervisory system compares the memory usage, the number of open files, the number of database connections, the number of pointers, etc., associated with the active process to stored baseline parameters. When the active process remains within the acceptable parameters, the supervisory system returns to monitoring and comparing the active service with the stored parameter data.

When the supervisory system determines that the active process is not operating within the stored parameter data, a switch to the passive process is made. That is, the supervisory system transfers processing from the active process to the passive process, thereby rendering the passive process as an active process. A new passive process is then initiated so as to replace the former passive process that has gone active. A terminating state transition is then communicated to the active process operating outside the parameter data by the supervisory system. The supervisory system then waits a predetermined period of time for the active process operating outside the acceptable parameter data to terminate. In accordance with one embodiment of the subject application, a timer is initiated upon transmission of the transition to terminating state command to the active process, the timeout of which prompts a determination as to whether the active process has terminated.

When it is determined that the process has successfully terminated, operations return to monitoring the active web services process, e.g., the former passive web services process. When the supervisory system determines that the active web services process operating outside the accepted parameters has not yet terminated, e.g., the process is non-responsive or a measured amount of time has elapsed after the transition to a terminating state command was issued, the supervisory system terminates the process, i.e., kills the non-acceptable active process. It will be appreciated by those skilled in the art that during this termination process, the former passive process continues performing the requested web services, responding back to the messaging system in XML format with processed data.

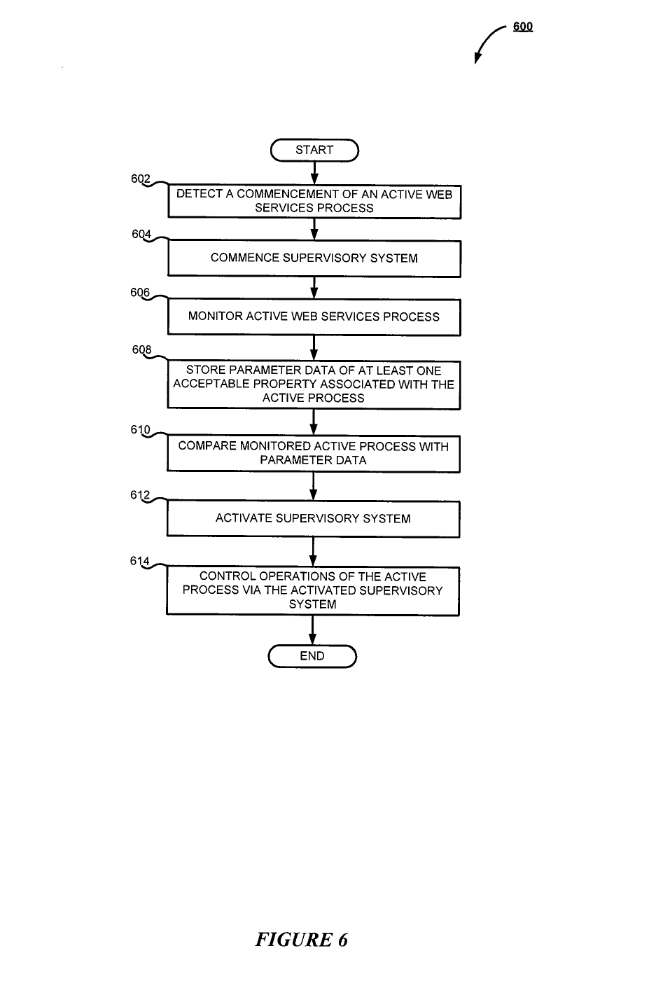

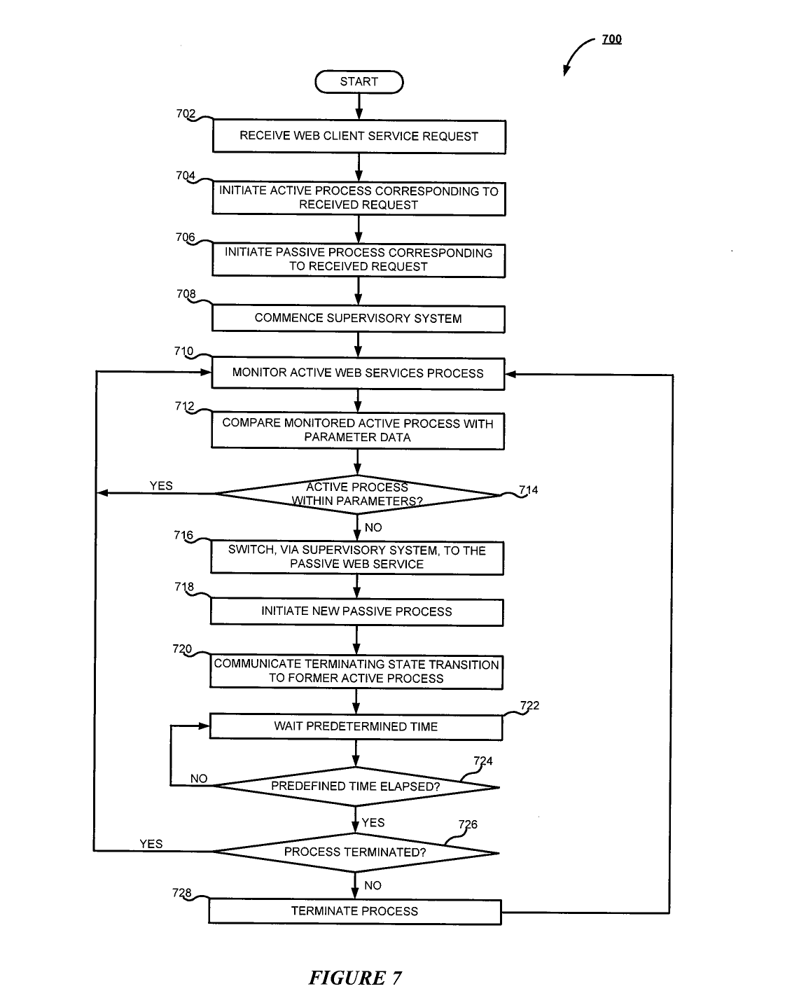

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for web process monitoring in accordance with one embodiment of the subject application. Beginning at step 602, a commencement of an active web services process is first detected. At step 604, responsive to the detection of the commencement of an active web services process, a supervisory system is commenced.

The active web services process is then monitored by the supervisory system at step 606. At step 608, parameter data of at least one acceptable property associated with the active web services process is stored. The monitored active web services process is then compared at step 610 with the stored parameter data. At step 612, the supervisory system is activated in accordance with the output of the comparison of the active web services process with the parameter data. Thereafter, at step 614, the operation of the active web services process is controlled via the activated supervisory system.

Referring now to FIG. 7, there is shown a flowchart 700 illustrating a method for web process monitoring in accordance with one embodiment of the subject application. The method depicted in FIG. 7 commences at step 702, whereupon a web client services request is received by a web services front end component of the server 114 from a user device 118 via the computer network 102. It will be appreciated by those skilled in the art that suitable web services components include, for example and without limitation, those web services components available via JAVA J2EE, Microsoft .NET framework, and the like. In accordance with one embodiment of the subject application, the web services request is an extensible markup language (XML) message communicated via the web services front end component of the server 114 to a messaging system component of the server 114, whereupon the request is added to a first-in-first-out message queue. The skilled artisan will appreciate that other suitable messaging, such as, for example and without limitation, XML remote procedure call (RPC), simple object access protocol (SOAP), SOAP with attachments, and the like, are also capable of being employed for communication of the web services request in accordance with the subject application. Thereafter, flow proceeds to step 704, whereupon an active web services process is initiated in accordance with the received web services request. At step 706, a passive web services process is initiated in accordance with the received web services request. Thus, it will be appreciated by those skilled in the art that the active and passive web services processes both correspond to processors capable of performing the requested service.

At step 708, a supervisory system component of the server 114, is commenced so as to monitor, at step 710, the active web services process. In accordance with one embodiment of the subject application, the supervisory system component retrieves stored parameter data from memory corresponding to normal operation of the active web services process. Preferably, the stored parameter data represents allowable memory usage, the allowable number of open files, the allowable number of database connections, the allowable number of pointers, or the like. The monitored active web services process is the compared, at step 712, with the stored parameter data.

A determination is then made at step 714 whether the active web services process is within the limits established by the stored parameter data. For example, a determination is made whether the active web services process is exceeding the allowable amount of memory, has exceeded the allowable number of open files, pointers, database connections, or the like. When the supervisory component determines that the active web services process is operating within the accepted parameters, i.e., normal operation, flow returns to step 710 for monitoring. When it is determined that the active web services process is not operating within the stored parameters, flow proceeds to step 716, whereupon the supervisory system component switches processing to the passive web services process. The skilled artisan will appreciate that the supervisory system component directs the passive web services process to become active and in effect, take over or continue the processing of the web services request from the active web services process that is currently operating outside the set parameters.

At step 718, a new passive web services process is initiated via the supervisory system component. A terminating state transition instruction is then communicated to the formerly active web services process at step 720 instructing the process to terminate. The supervisory system component then waits a predetermined period of time for the formerly active web services process to terminate. In accordance with one embodiment of the subject application, the waiting includes measuring a timing associated with the activation of the supervisory system, e.g., the communication of the termination instruction. A determination is made at step 724 whether the predefined period of time has elapsed, e.g., whether a pre-set timeout duration has occurred.

When the predetermined period of time has not elapsed, operations return to step 722, whereupon the supervisory system component continues to wait for the period to expire. When the supervisory system component determines, at step 724, that the time has elapsed, the supervisory system component then ascertains the status of the formerly active web services process. That is, the supervisory system component determines, at step 726, whether or not the formerly active web services process has successfully terminated in response to the termination s instruction. When the supervisory system component determines that the formerly active web services process has terminated, flow returns to step 710, whereupon the supervisory system component monitors the active web services process, i.e., the former passive web services process that is now active. Upon a determination at step 726 that the formerly active web services process has not yet terminated, e.g., it is non-responsive, flow proceeds to step 728, whereupon the supervisory system component terminates the operations of the non-responding web services process. Flow then returns, from step 728, to step 710, whereupon the supervisory system component continues the monitoring of the active web services process, e.g., the formerly passive web services process.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A web process monitoring system comprising:
detection means adapted for detecting a commencement of an active web services process;
responsive to the detection means, means adapted for commencing a supervisory system upon detection of a commenced active web services process;
monitoring means adapted for monitoring the active web services process;
means adapted for storing parameter data representative of at least one acceptable property associated with the active web services process;
comparison means adapted for comparing a monitored active web services process with stored parameter data;
means adapted for activating the supervisory system in accordance with an output of the comparison means; and
control means adapted for controlling operation of the active web services process via an activated supervisory system.

2. The system of claim 1 wherein parameter data includes data representative of at least one characteristic chosen from the set comprising memory usage, number of open files, number of database connections, and number of pointers.

3. The system of claim 2 wherein the control means includes termination means adapted for terminating the active web services process.

4. The system of claim 3 further comprising means adapted for commencing a subsequent active web services process upon termination of a prior active web services process.

5. The system of claim 3 further comprising:
a timer adapted for measuring a timing associated with activation of the supervisory system; and
termination control means adapted for controlling the termination means in accordance with an output of the timer.

6. The system of claim 5 wherein the termination control means operates in accordance with a pre-set timeout duration.

7. A method for web process monitoring comprising the steps of:
detecting a commencement of an active web services process;
responsive to the step of detecting, commencing a supervisory system upon detection of a commenced active web services process;
monitoring the active web services process;
storing parameter data representative of at least one acceptable property associated with the active web services process;
comparing a monitored active web services process with stored parameter data;
activating the supervisory system in accordance with an output of the comparison; and
controlling operation of the active web services process via an activated supervisory system.

8. The method of claim 7 wherein parameter data includes data representative of at least one characteristic chosen from the set comprising memory usage, number of open files, number of database connections, and number of pointers.

9. The method of claim 8 wherein the step of controlling operation of the active web services process includes the step of terminating the active web services process.

10. The method of claim 9 further comprising the step of commencing a subsequent active web services process upon termination of a prior active web services process.

11. The system of claim 9 further comprising the steps of:
measuring a timing associated with activation of the supervisory system; and
controlling the step of terminating the active web services process in accordance with an output of the timer.

12. The method of claim 11 wherein the step of terminating the active web services process is in accordance with a pre-set timeout duration.

13. A computer-implemented method for web process monitoring comprising the steps of:
detecting a commencement of an active web services process;
responsive to the step of detecting, commencing a supervisory system upon detection of a commenced active web services process;
monitoring the active web services process;
storing parameter data representative of at least one acceptable property associated with the active web services process;
comparing a monitored active web services process with stored parameter data;
activating the supervisory system in accordance with an output of the comparison; and
controlling operation of the active web services process via an activated supervisory system.

14. The computer-implemented method of claim 13 wherein parameter data includes data representative of at least one characteristic chosen from the set comprising memory usage, number of open files, number of database connections, and number of pointers.

15. The computer-implemented method of claim 14 wherein the step of controlling operation of the active web services process includes the step of terminating the active web services process.

16. The computer-implemented method of claim 15 further comprising the step of commencing a subsequent active web services process upon termination of a prior active web services process.

17. The computer-implemented system of claim 15 further comprising the steps of:
measuring a timing associated with activation of the supervisory system; and
controlling the step of terminating the active web services process in accordance with an output of the timer.

18. The computer-implemented method of claim 17 wherein the step of terminating the active web services process is in accordance with a pre-set timeout duration.
